(19) United States
(12) Patent Application Publication
(10) Pub. No.: US 2010/0066770 A1
(43) Pub. Date: Mar. 18, 2010

(54) Pulse Width Modulation Display Pixels with Spatial Manipulation

(75) Inventors: John R. Fredlund, Rochester, NY (US); John A. Agostinelli, Rochester, NY (US)

Correspondence Address: EASTMAN KODAK COMPANY;PATENT LEGAL STAFF, 343 STATE STREET, ROCHESTER, NY, 14650-2201, US

(73) Assignee: Eastman Kodak Company, Rochester, NY (US)

(21) Appl. No.: 12/212,785

(22) Filed: Sep. 18, 2008

(51) Int. Cl. G09G 5/10; G09G 3/34

(52) U.S. Cl. 345/691; 345/84

(57) ABSTRACT

Systems and methods of producing images are provided. Data corresponding to a first set of display pixels is received. When it is determined that a transition occurs in the first set of display pixels, a position of at least one display pixel in the first set of display pixels is adjusted based on the determined transition. The adjustment can involve adjusting a center of a pulse that causes formation of the display pixel away from a center of a modulation window.

### FIELD OF THE INVENTION

Exemplary embodiments of the present invention are directed to display devices, and in particular, to spatial manipulation of display pixels in such devices.

### BACKGROUND OF THE INVENTION

Image and video reproduction typically involves receiving image or video data and providing a corresponding output image comprising a plurality of display pixels. A variety of display technologies are known, including cathode ray tube (CRT), liquid crystal display (LCD), plasma, digital light processing (DLP), grating electro mechanical system (GEMS), grating light valve (GLV) and the like.

A display system that employs GEMS devices uses a linear array of GEMS devices to modulate incident light to produce a line of pixels. A galvanometer (also referred to as a scanning mirror) sweeps the line image across a screen to form a two-dimensional image. FIG. 1A illustrates an exemplary portion of an image output by a GEMS display system and FIG. 1B illustrates an exemplary input waveform that directs modulation of lasers to generate display pixels in a GEMS display system. A GEMS display system employs pulse width modulation (PWM) signals to direct modulation of one or more lasers to generate the display pixels, where the width of the pulse determines the resulting pixel brightness. A color GEMS display system employs a red, green and blue laser, each of which diffract off of a GEMS device to form an image. Conventionally, as disclosed in U.S. Pat. No. 7,148,910 to Stauffer et al and in U.S. Pat. No. 6,621,615 to Kruschwitz et al, the light pulses generated using pulse-width modulation of the GEMS device, result in display pixels that are each centered on the line of display pixels. Thus, as illustrated in FIGS. 1A and 1B, a blue laser is directed by a GEMS device with a voltage corresponding to a high state during the first three modulation windows to produce blue pixels in the first three display columns, and a red laser is directed by a GEMS device with a voltage corresponding to a high state during the third through fifth modulation windows to produce red pixels in the third through fifth display columns. As illustrated in FIGS. 1A and 1B, the pulses are centered within the modulation window, and this produces pixels centered within a display column.

### SUMMARY OF THE INVENTION

It has been recognized that color reproduction and/or image sharpness of images produced by conventional display systems using one dimensional light valve arrays together with one dimensional scanners, can be improved by spatial manipulation of display pixels. Regarding color reproduction, centering of pixels within a display column for portions of an image in which there is a transition between colors, as is performed, for example, by conventional GEMS display systems, can result in inaccurate color reproduction. For example, referring again to FIG. 1A, a purple pixel may be displayed in the third column where there is a transition between blue and red pixels. Regarding image sharpness, the centering of the display pixels within the display columns can result in an image in which edges lack sharpness when there is a transition between different colored pixels in adjacent display columns.

Shifting of scanned display pixels for the purpose of improved image reproduction, as described above for one dimensionally scanned imaging systems, can also be employed in two-dimensionally scanned imaging systems, for example, laser scanners having 2-axis mirror scanners.

In view of the above-identified and other deficiencies of conventional display systems, exemplary embodiments of the present invention are directed to spatial manipulation of pixels in a display device. An exemplary method involves receiving data corresponding to a first set of display pixels. When it is determined that a transition occurs in the first set of display pixels, a position of at least one display pixel in the first set of display pixels is adjusted based on the determined transition. The adjustment can involve adjusting a center of a pulse that causes formation of the display pixel away from a center of a modulation window.

A system includes an output component that forms an image comprising a first set of display pixels and a processor that is coupled to the output component. The processor receives data corresponding to the first set of display pixels. The processor includes logic that determines that a transition occurs in the first set of display pixels and logic that adjusts a position of at least one display pixel in the first set of display pixels based on the determined transition.

Other objects, advantages and novel features of the present invention will become apparent from the following detailed description of the invention when considered in conjunction with the accompanying drawings.

### BRIEF DESCRIPTION OF THE DRAWINGS

FIGS. 1A and 1B respectively illustrate a set of display pixels and voltage waveforms that direct modulation of lasers to generate the display pixels in a conventional system;

FIGS. 2A-5B illustrate a set of display pixels and voltage waveforms that direct modulation of lasers to generate the display pixels in accordance with exemplary embodiments of the present invention;

FIG. 6 is a block diagram of an exemplary projection display device in accordance with the present invention;

FIG. 7 is a flow diagram of an exemplary method in accordance with the present invention;

FIG. 8 is a flow diagram of another exemplary method in accordance with the present invention;

FIGS. 9A and 9B respectively illustrate a set of display pixels and voltage waveforms that direct modulation of lasers to generate the display pixels in a conventional system;

FIGS. 10A and 10B illustrate a set of display pixels and voltage waveforms that direct modulation of lasers to generate the display pixels in accordance with exemplary embodiments of the present invention;

FIGS. 11A and 11B respectively illustrate a set of display pixels and voltage waveforms that direct modulation of lasers to generate the display pixels in a conventional system; and

FIGS. 12A-13B illustrate a set of display pixels and voltage waveforms that direct modulation of lasers to generate the display pixels in accordance with exemplary embodiments of the present invention.

### DETAILED DESCRIPTION OF THE INVENTION

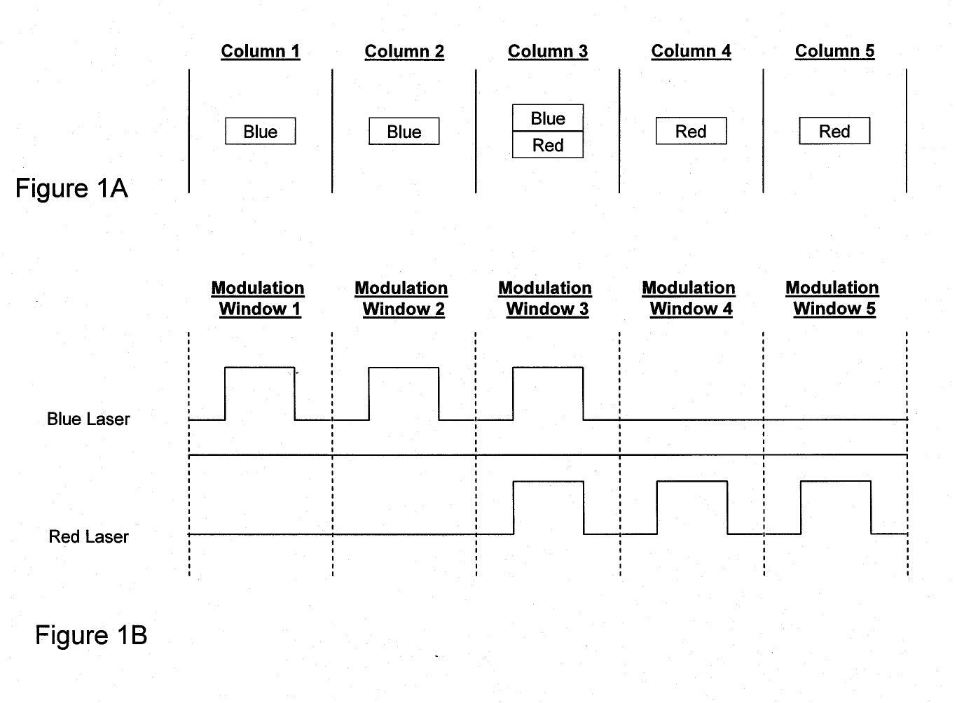

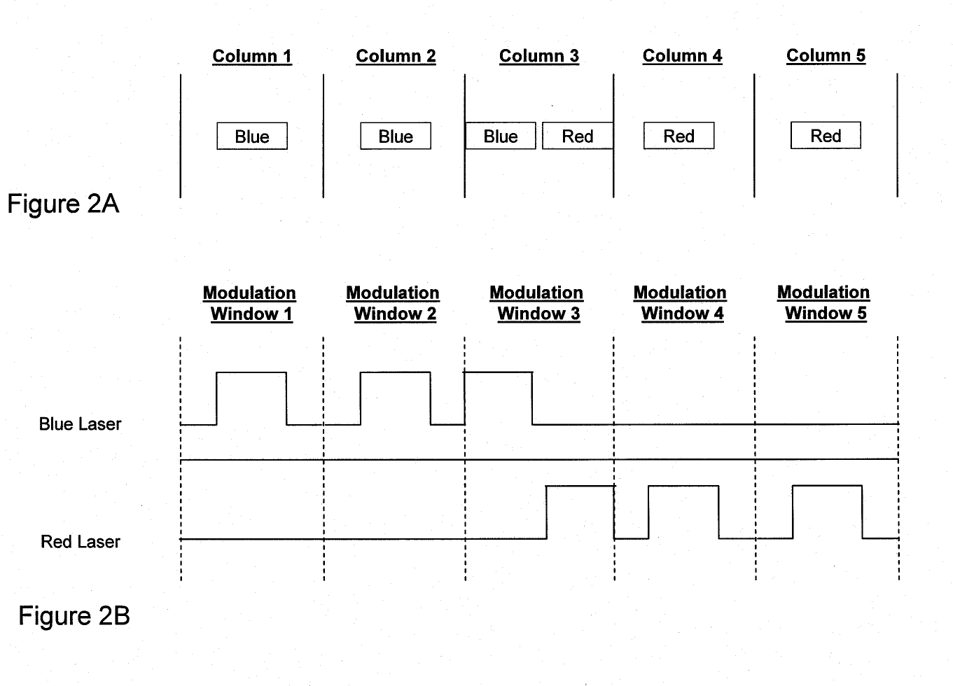

FIGS. 2A-5B illustrate exemplary spatial manipulation of pixels in accordance with the present invention. These figures assume that the input image data is the same that is used in FIGS. 1A and 1B. A detector is used to determine a transition exceeding some predefined threshold such as that described by William K. Pratt in Digital Image Processing, pp. 491-556. The detector may be implemented in hardware or software. As illustrated in FIG. 2A, the center of the blue pixel in the third display column can be shifted to the left and the center of the red pixel in the third display column can be shifted to the right. Thus, as illustrated in FIG. 2B, this is achieved by shifting the center of the pulse that directs the modulated blue laser light towards the preceding modulation window and shifting the center of the pulse that directs the modulated red laser light towards the subsequent modulation window. Although exemplary embodiments are disclosed in connection with the use of lasers as a light source, any light source that can be both pulse width modulated and spatially scanned can be used to practice the invention

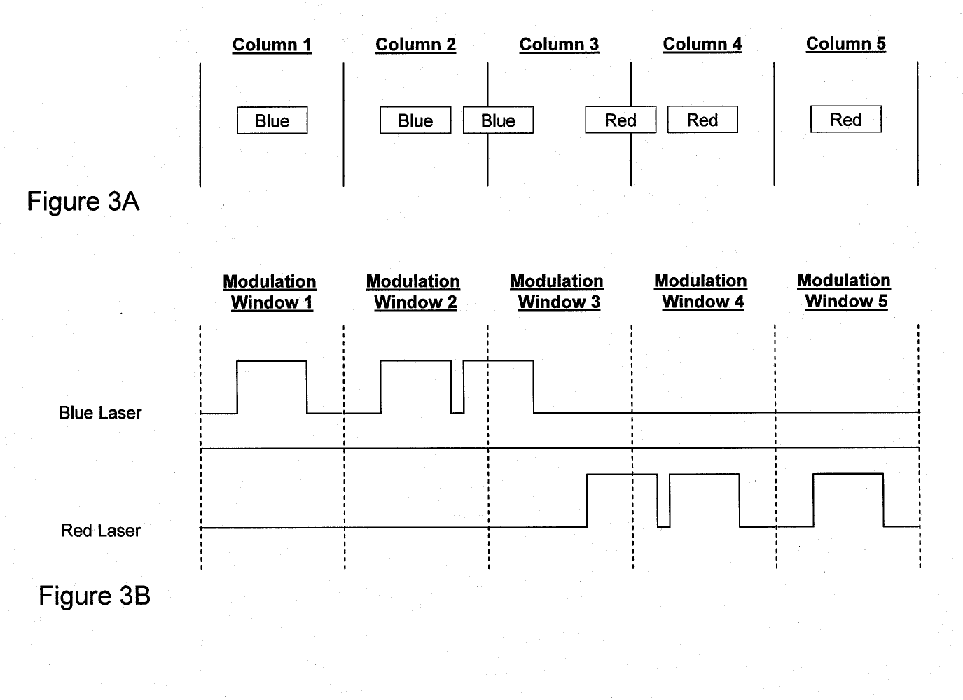

FIGS. 3A and 3B are similar to that of FIGS. 2A and 2B except that the pixels are shifted into an adjacent display column. Thus, as illustrated in FIG. 3B, the center of the pulse that directs the modulation of the blue laser is shifted such that a portion of the pulse occurs in the previous modulation window, and the center of the pulse that directs the modulation of the red laser is shifted such that a portion of the pulse occurs in the subsequent modulation window.

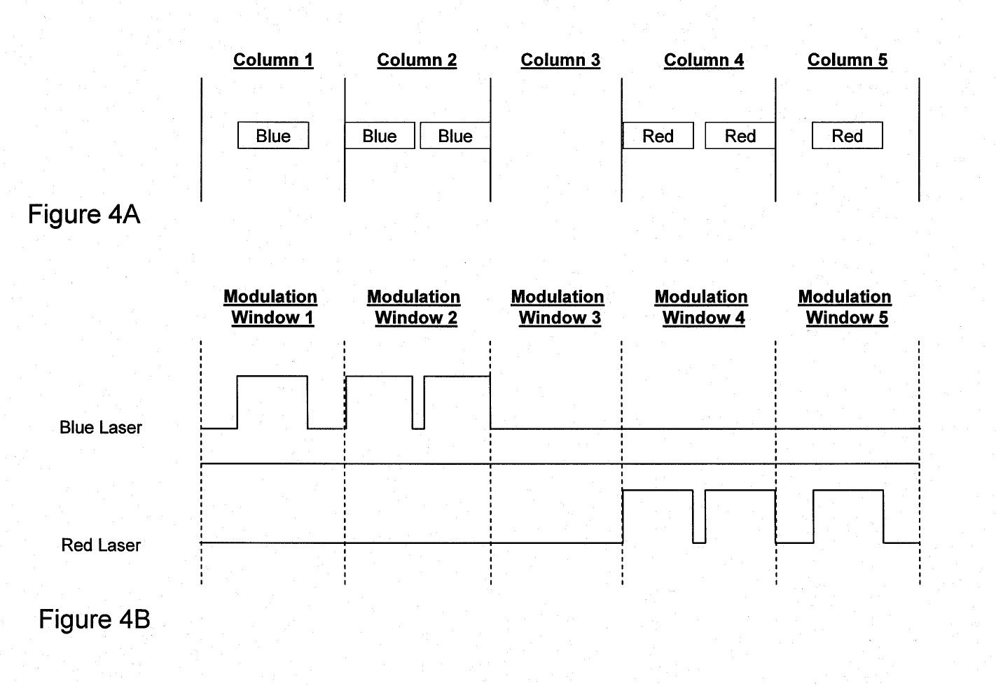

In FIGS. 4A and 4B, the blue and red pixels, which in FIG. 1A are reproduced in the third display column, are shifted entirely into an adjacent column. Thus, as illustrated in FIG. 4B, the blue pulse originally produced in the third modulation window is shifted entirely into the second modulation window, and the blue pulse that was centered in the second modulation window is shifted towards the previous modulation window, while still providing some spatial separation from the pulse shifted from the third modulation window. This spatial separation is described by way of example and is not necessary in practice. Additionally, the blue display pixel that was previously centered within display column 2 has its center shifted towards display column 1, and the red pixel that was previously centered within display column 4 has its center shifted towards display column 5.

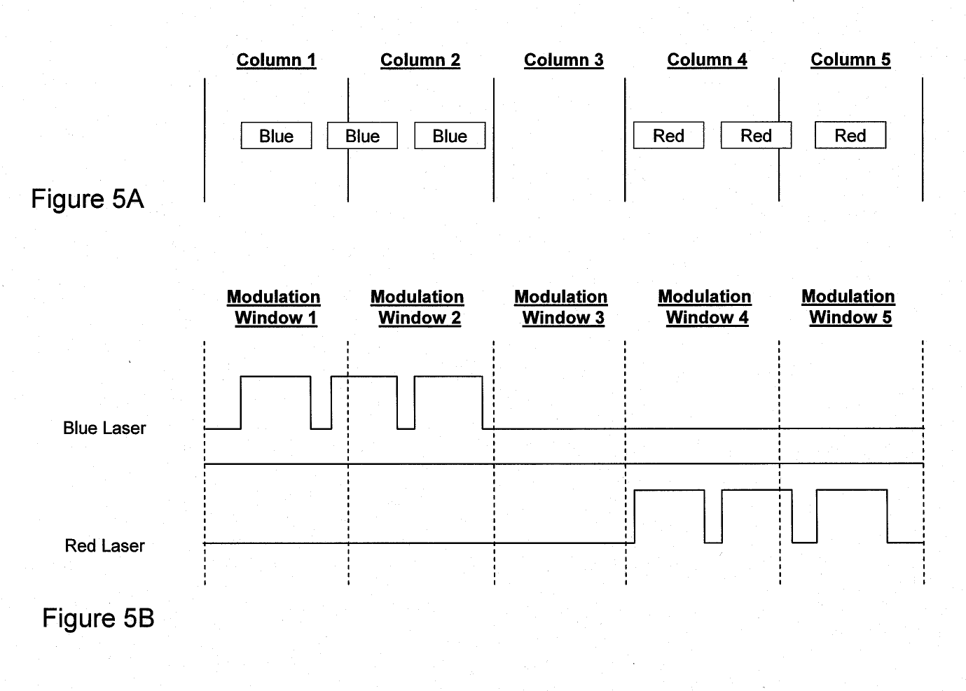

FIGS. 5A and 5B are similar to that of FIGS. 4A and 4B except that the pixels that in display columns 2 and 5 that were shifted due to the shift of pixels from display column 3, are shifted into the previous display column (for the blue pixel) and into the subsequent display column (for the red pixel). Accordingly, the corresponding pulses are shifted into the previous modulation window (for the pulse that directs the modulation of the blue laser) and into the subsequent modulation window (for the pulse that directs modulation of the red laser).

It should be recognized that the particular shifting of pixels and pulses are merely exemplary and that other types of shifts can be employed. Furthermore, although the examples above are described only in connection with red and blue lasers, the present invention is equally applicable to any laser color that is employed in a display system. Single lasers or combinations of lasers may be manipulated in the manner described by the invention.

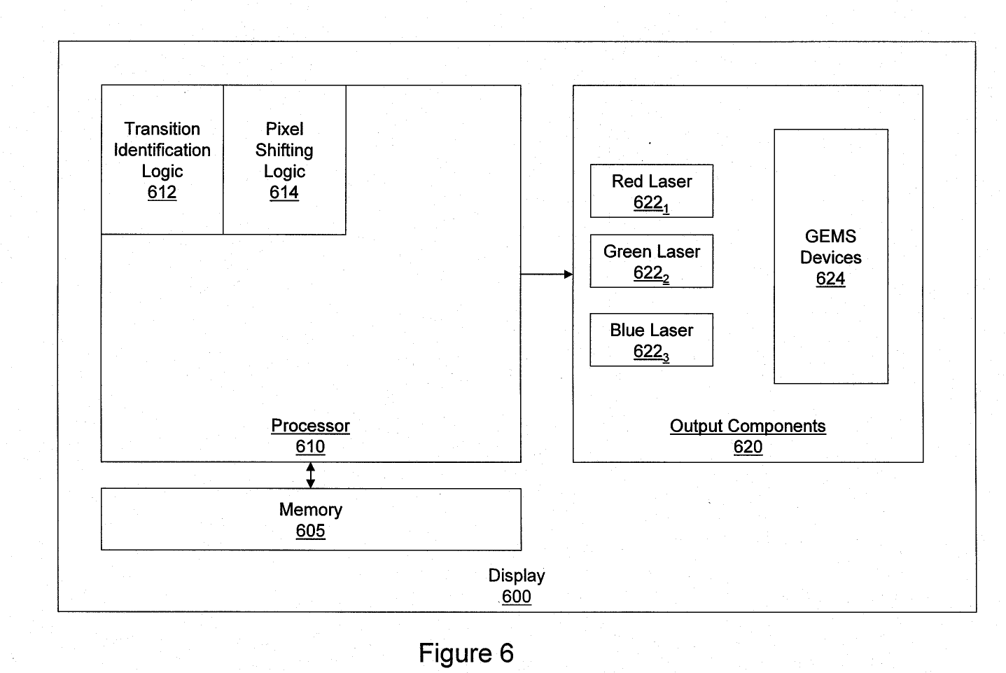

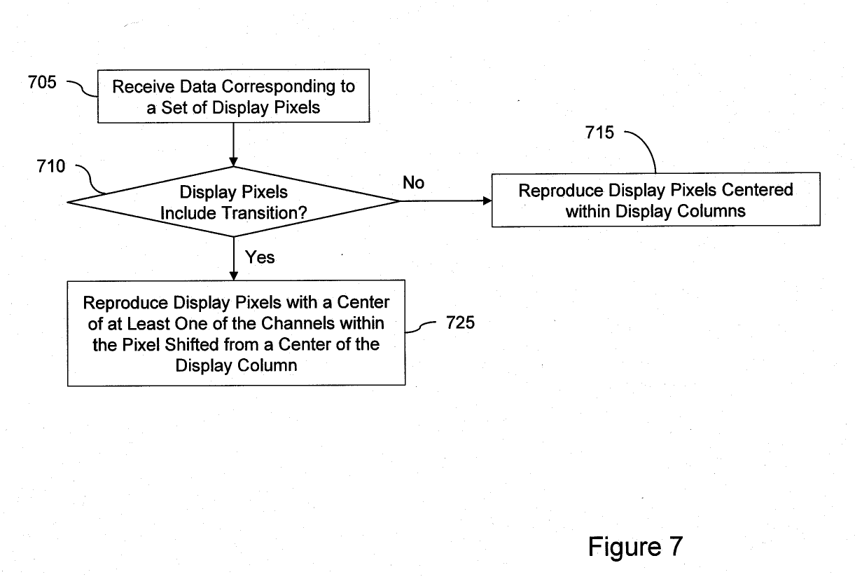

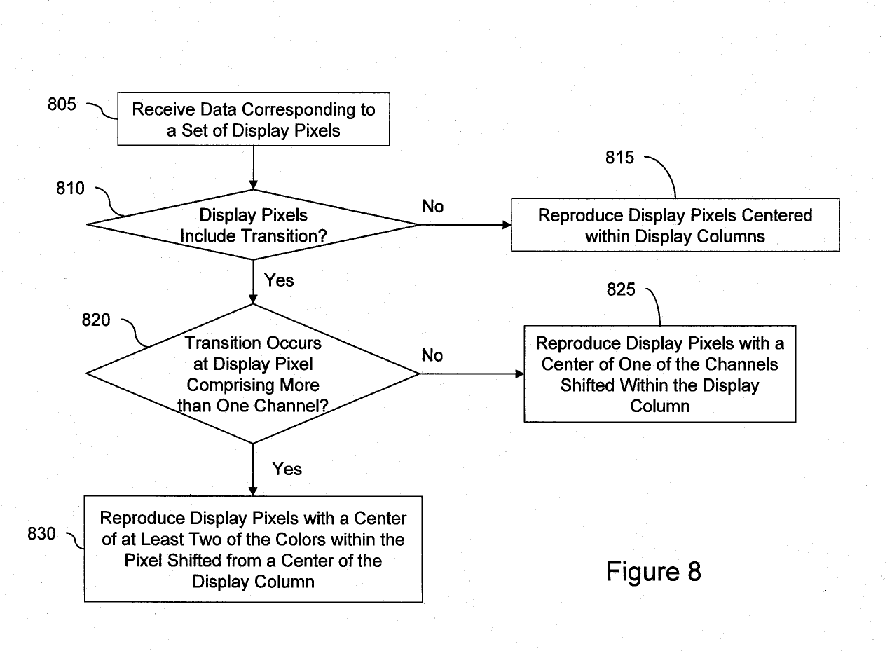

FIG. 6 is a block diagram of an exemplary projection display device in accordance with the present invention. Projection display device 600 includes processor 610 coupled to memory 605 and output components 620. Processor 610 includes logic 612 and 614, which will be described in more detail below in connection with FIGS. 7 and 8. Processor 610 can be any type of processor, such as a microprocessor, field programmable gate array (FPGA) and/or an application specific integrated circuit (ASIC). When processor 610 is a microprocessor then logic 612 and 614 can be computer-executable code loaded from memory 605 or any other type of computer-readable media. Output components 620 includes red laser 622₁, green laser 622₂ and blue laser 622₃, as well as GEMS devices 624. It will be recognized that FIG. 6 is a simplified diagram of a display device, and the display device can include other components, such as mirrors, lenses, galvanometers, a display screen, additional processors, additional memories, inputs, outputs, etc. Moreover, the output components can include more or fewer lasers, different colored lasers and/or any light source that can be both pulse width modulated and spatially scanned.

FIG. 7 is a flow diagram of an exemplary method in accordance with the present invention. Initially, processor 610 receives a set of data corresponding to a set of display pixels (step 705). Logic 612 then determines whether the display pixels include a transition (step 710). The detection of a transition can employ any type of edge detection or color transition technique, which can employ all color channels and/or a single luminance channel. For example, the values in a color channel can be monitored, and a transition is detected when the change of value from one pixel to the next is greater than a threshold value. This threshold can be employed on a per pixel basis or can be a gradient across a number of pixels. In addition to, or as an alternative to, a transition analysis based on pixels within the same horizontal line, the transition analysis can involve pixels in adjacent horizontal lines, i.e., a vertical component.

The term “channel” is used to denote a particular color of light. Although exemplary embodiments are described in connection with any given pixel being composed of two or three channels of light (red, green and blue), the present invention is not limited to these channels and can be practiced with channels of any number or wavelength. From the perspective of the output display screen, in a pulse width modulation system, each channel is on for a specified fraction of the total time allotted for each pixel. The specified fraction can be zero.

When the display pixels do not include a transition, (“No” path out of decision step 710), then processor 610 controls output components to reproduce the display pixels such that the display pixels are centered within the display columns (step 715).

Whereas in conventional systems the amount of time any channel is on for a given pixel is centered in the space allotted for that pixel, the present invention moves the centering of the on time for each pixel in accordance with the pulse width of the channel off center towards adjacent or nearly adjacent pixels. Accordingly, when logic 612 determines that the display pixels include a transition in a channel in step 710, then logic 614 controls output components 620 such that the display pixels are reproduced with the center of at least one display pixel being shifted from a center of the display column (step 725).

FIG. 7 represents a condition where only a single color channel is determined to have a transition, which is uncommon. Accordingly, the method of FIG. 8 addresses transitions in more than one color channel. As shown in FIG. 8, when logic 612 determines that the display pixels include a transition (“Yes” path out of decision step 810), then logic 612 determines whether the transition occurs at a display pixel that includes more than one channel (step 820). When the transition occurs at a display pixel that includes more than one channel (“Yes” path out of decision step 820), then logic 614 controls output components 620 such that the display pixels are reproduced with the center of at least two of the channels within a display pixel being shifted from a center of the display column (step 830). When the transition occurs at a display pixel that includes only one color (“No” path out of decision step 820), then logic 614 controls output components 620 such that the display pixels are reproduced with a center of at least one of the display pixels being shifted within the display column (step 825). The spatial manipulation of display pixels in steps 825 and 830 can involve any of the spatial manipulation techniques described above.

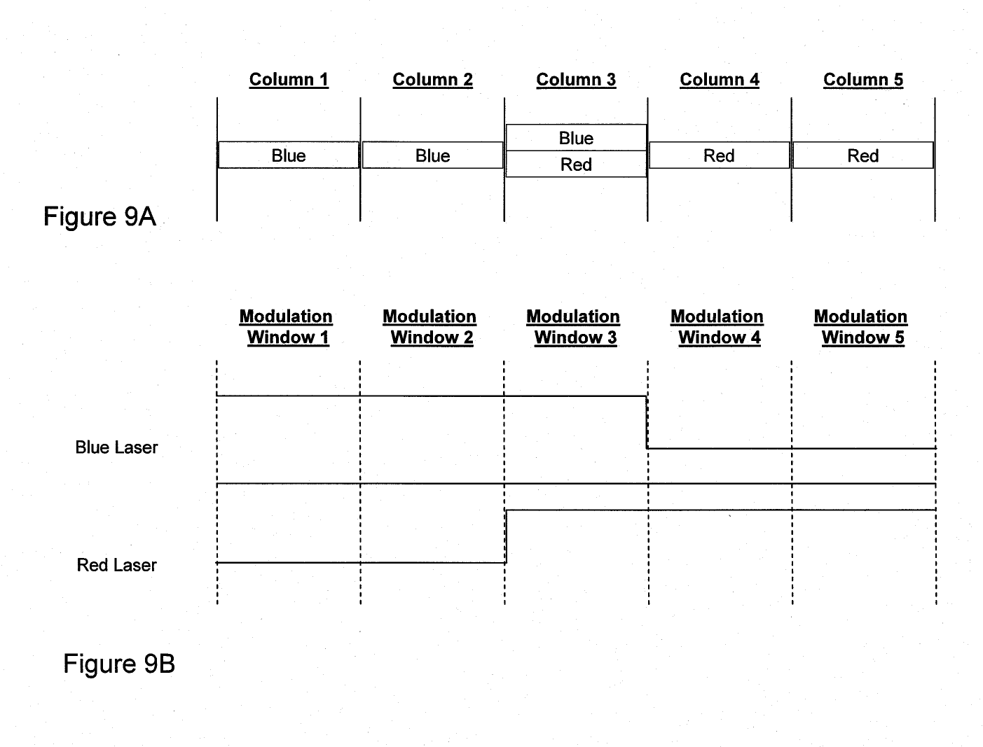

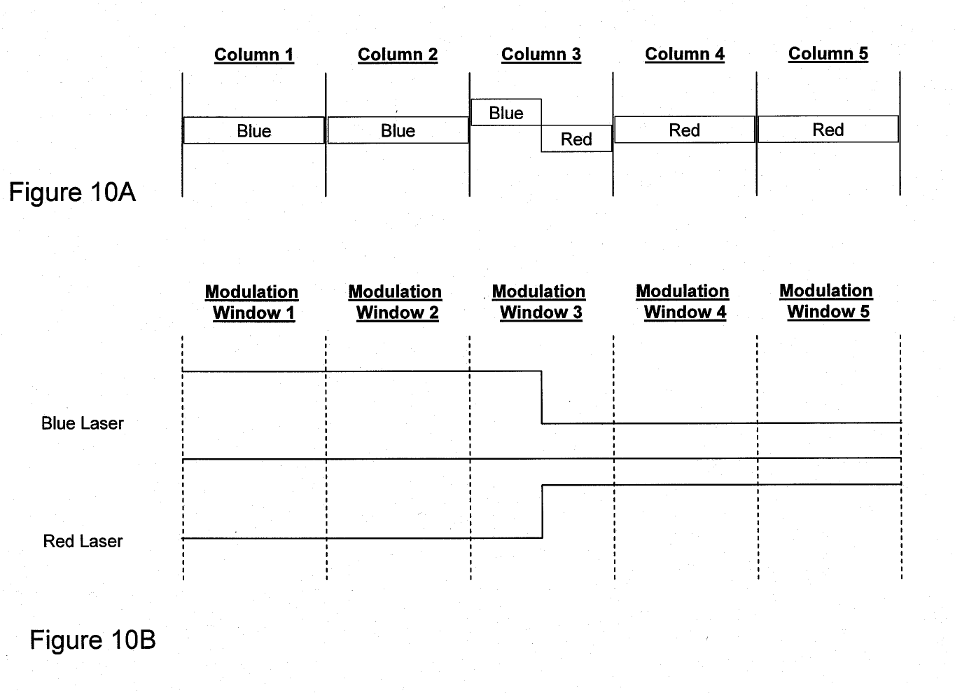

It should be recognized that in certain situations the above-described embodiments may require further refinement. For example, as illustrated in FIGS. 9A and 9B, the center of the blue pixel in the third display column cannot be shifted to the left and the center of the red pixel in the third display column cannot be shifted to the right because both channels are on for the entire modulation window for display column 3. Additionally, the adjacent pixels toward which the center of the pixels in display column 3 would be shifted are on for the entire modulation window. Thus, an additional refinement of the invention is shown in FIGS. 10A and 10B. In this case, the duration of the pulse width for each of the channels in display column 3 is reduced. The on time for the blue channel has been reduced to 50% and the on time for the red channel has been reduced to 50%. This allows movement of the center of the pixel in the manner described above. Specifically, the center of the blue pixel is moved toward the adjacent blue pixel in display column 2, and the center of the red pixel is moved toward the adjacent red pixel in display column 4. While this implementation has been described for two channels, it can also be practiced with a single channel or more than two channels.

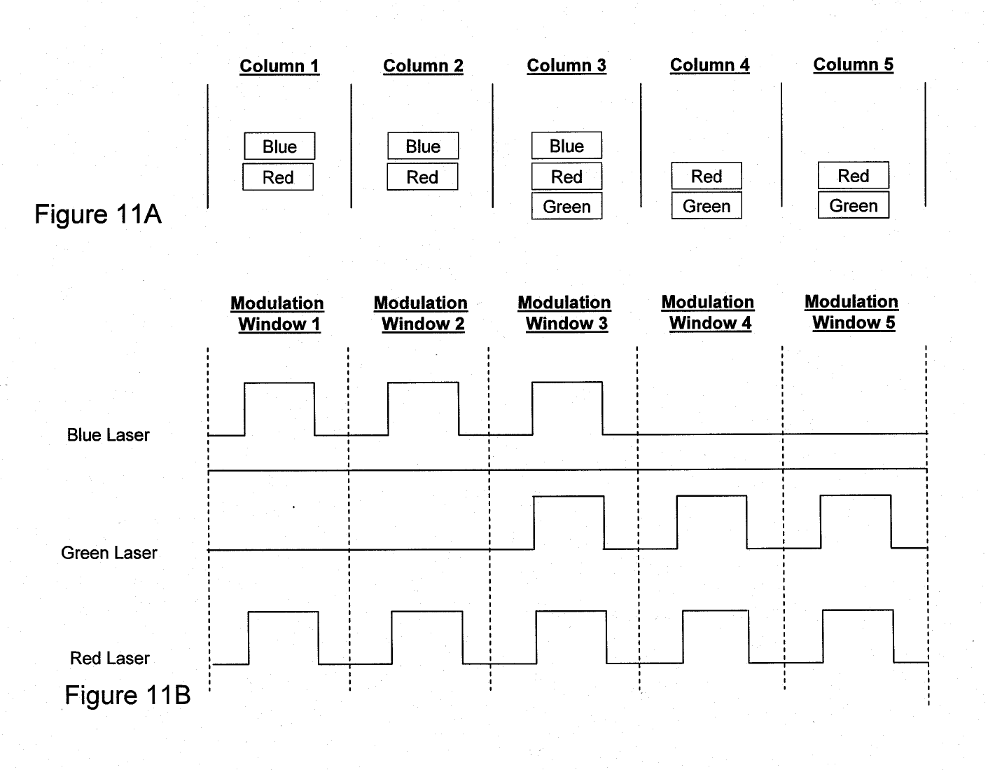

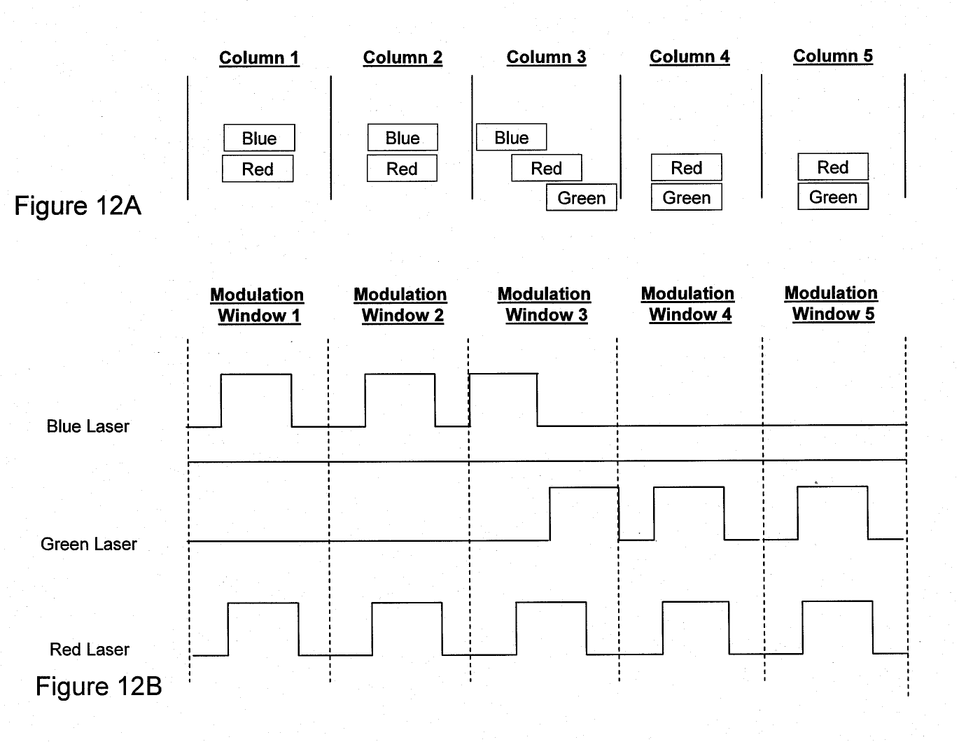

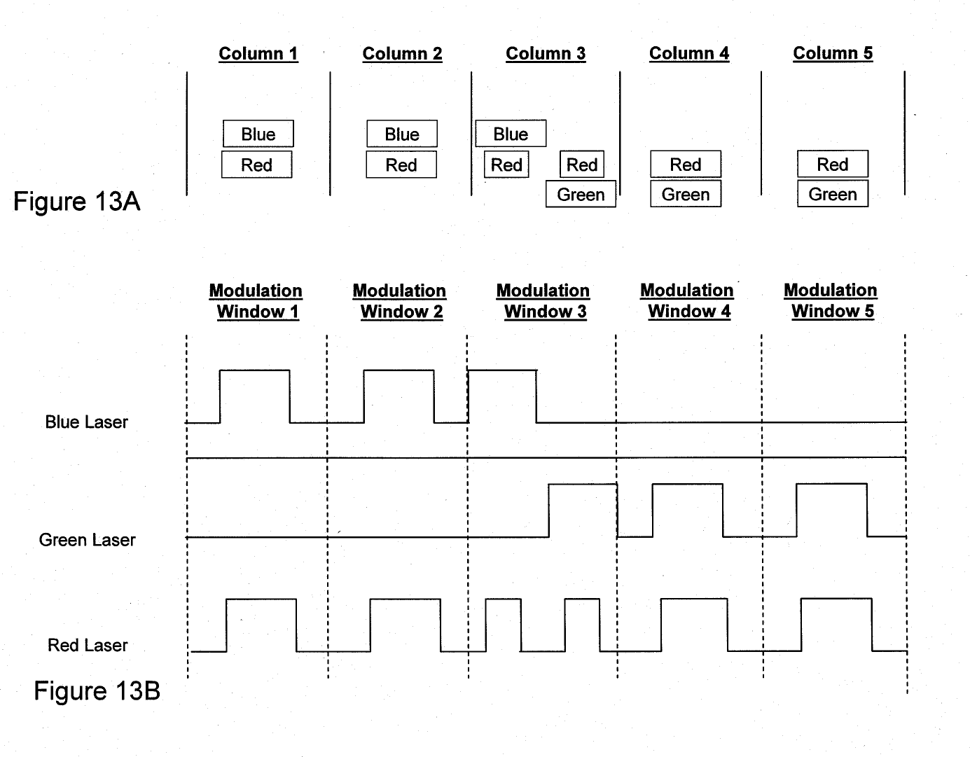

FIGS. 11A and 11B illustrate an example of a prior art transition where more than two channels are involved. In this case, the transition is from purple (red and blue) to yellow (red and green). FIGS. 12A and 12B illustrate an embodiment of the invention where the blue and green pixels have been shifted in display column 3. Note that the blue and green pixels may be moved beyond column boundaries consistent with the invention as described previously. FIGS. 13A and 13B illustrate an embodiment where transitions in the blue and green channels have effect on the red channel. In this case, the red pixel has been split into two sub pixels that fall within display column 3. For display column 3, the total on time for the red channel has been maintained, but this need not be the case. The duration of the sub pixels and the location of the center of the sub pixel may be altered to preserve color fidelity or enhance the sharpening effect. Note that the sub pixels may be moved beyond column boundaries consistent with the invention as described previously.

Although exemplary embodiments have been described in connection with displays that employ GEMS technology, the present invention is equally applicable to other types of display technologies, such as, for example, grating light value (GLV) technology developed by Silicon Light Machines and Sony. Moreover, although exemplary embodiments have been described above in connection with one dimensional scanned imaging systems, exemplary embodiments can also be employed in two-dimensionally scanned imaging systems, for example, laser scanners having 2-axis mirror scanners.

The invention has been described in detail with particular reference to certain preferred embodiments thereof, but it will be understood that variations and modifications can be effected within the spirit and scope of the invention.

1. A method of producing an image, the method comprising the acts of:
receiving data corresponding to a first set of display pixels;
determining that a transition occurs in the first set of display pixels; and
adjusting a position of at least one display pixel in the first set of display pixels based on the determined transition.

2. The method of claim 1, wherein the adjustment of the position of the at least one display pixel comprises the act of:
adjusting a center of a pulse that causes formation of the display pixel away from a center of a modulation window.

3. The method of claim 2, wherein the pulse is a pulse that directs modulation of a laser.

4. The method of claim 2, wherein the center of the pulse is adjusted such that a portion of the display pixel is moved into a display column of an adjacent display pixel.

5. The method of claim 1, wherein when the at least one display pixel comprises more than one color, the adjustment of the position of the display pixel comprises the acts of:
adjusting a position of one of the colors in a direction of a previous display column; and
adjusting a position of another of the colors in a direction of a subsequent display column.

6. The method of claim 5, wherein the position of the one of the colors is shifted such that a portion of the one of the colors is in the previous display column.

7. The method of claim 6, wherein the position of the one of the colors is shifted such that the entire color is in the previous display column.

8. The method of claim 7, wherein a position of a display pixel in the previous display column is shifted towards a display column adjacent to the previous display column.

9. The method of claim 1, wherein a size of the at least one display pixel is reduced.

10. The method of claim 9, wherein the size of the at least one display pixel is reduced when the at least one display pixel, prior to reduction in size, occupies substantially an entire width of a display column.

11. The method of claim 1, wherein the at least one display pixel comprises more than one color, the method further comprising the acts of:
reducing a width of a pulse that directs modulation of a laser of a first of the colors;
adjusting a center of the pulse that directs modulation of the laser of the first of the colors; and
adjusting a center of a pulse that directs modulation of a laser of a second of the colors.

12. The method of claim 1, wherein the first set of display pixels is displayed on a same horizontal display line.

13. The method of claim 1, wherein the determination of the transition is performed using a single luminance channel.

14. The method of claim 1, wherein the transition is a color transition.

15. The method of claim 1, wherein the transition is an edge in an image formed by the first set of display pixels.

16. A system that produces an image, the system comprising:
an output component that forms an image comprising a first set of display pixels; and
a processor, coupled to the output component, the processor receiving data corresponding to the first set of display pixels, and the processor comprising
logic that determines that a transition occurs in the first set of display pixels; and
logic that adjusts a position of at least one display pixel in the first set of display pixels based on the determined transition.

17. The system of claim 16, wherein the adjustment of the position of the at least one display pixel involves adjusting a center of a pulse that causes formation of the display pixel away from a center of a modulation window.

18. The system of claim 17, wherein the pulse is a pulse that directs modulation of a laser of the output component.

19. The system of claim 17, wherein the center of the pulse is adjusted such that a portion of the display pixel is moved into a display column of an adjacent display pixel.

20. The system of claim 16, wherein when the at least one display pixel comprises more than one color, the adjustment of the position of the display pixel involves adjusting a position of one of the colors in a direction of a previous display column and adjusting a position of another of the colors in a direction of a subsequent display column.

21. The system of claim 20, wherein the position of the one of the colors is shifted such that a portion of the one of the colors is in the previous display column.

22. The system of claim 21, wherein the position of the one of the colors is shifted such that the entire color is in the previous display column.

23. The system of claim 22, wherein a position of a display pixel in the previous display column is shifted towards a display column adjacent to the previous display column.

24. The system of claim 16, wherein a size of the at least one display pixel is reduced.

25. The system of claim 24, wherein the size of the at least one display pixel is reduced when the at least one display pixel, prior to reduction in size, occupies substantially an entire width of a display column.

26. The system of claim 16, wherein the at least one display pixel comprises more than one color, a width of a pulse that directs modulation of a laser of a first of the colors is reduced, a center of the pulse that directs modulation of the laser of the first of the colors is adjusted, and a center of a pulse that directs modulation of a laser of a second of the colors is adjusted.
